(19) United States
(12) Patent Application Publication
(10) Pub. No.: US 2006/0184556 A1
(43) Pub. Date: Aug. 17, 2006

(54) Compression algorithm for generating compressed databases

(75) Inventors: Teewoon Tan, Roseville (AU); Stephen Gould, Killara (AU); Darren Williams, Newtown (AU); Ernest Peltzer, Eastwood (AU); Robert Matthew Barrie, Double Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/326,123

(22) Filed: Jan. 4, 2006

Related U.S. Application Data
(60) Provisional application No. 60/654,224, filed on Feb. 17, 2005.

(51) Int. Cl. G06F 17/00

(52) U.S. Cl. 707/101

(57) ABSTRACT

A data compressor performing the compression algorithm compresses an original uncompressed pattern database to form an associated compressed pattern database configured for fast retrieval and verification. For each data pattern, the data compressor stores a data in an address of a first memory table and that is defined by a first segment of a group of bits associated with the data pattern. The data compressor stores a second data in an address of a second memory table and that is defined by a second segment of the group of bits associated with the data pattern and further defined by the first data stored in the first memory.

### CROSS-REFERENCES TO RELATED APPLICATIONS

The present application claims benefit under 35 USC 119(e) of U.S. provisional application No. 60/654,224, attorney docket number 021741-001900US, filed on Feb. 17, 2005, entitled “Apparatus And Method For Fast Pattern Matching With Large Databases” the content of which is incorporated herein by reference in its entirety.

The present application is related to copending application Ser. No. ______, entitled “Fast Pattern Matching Using Large Compressed Databases”, filed contemporaneously herewith, attorney docket no. 021741-001920US, assigned to the same assignee, and incorporated herein by reference in its entirety.

### BACKGROUND OF THE INVENTION

The present invention relates to the inspection and classification of high speed network traffic, and more particularly to the acceleration of classification of network content using pattern matching where the database of patterns used is relatively large in comparison to the available storage space.

Efficient transmission, dissemination and processing of data are essential in the current age of information. The Internet is an example of a technological development that relies heavily on the ability to process information efficiently. With the Internet gaining wider acceptance and usage, coupled with further improvements in technology such as higher bandwidth connections, the amount of data and information that needs to be processed is increasing substantially. Of the many uses of the Internet, such as world-wide-web surfing and electronic messaging, which includes e-mail and instant messaging, some are detrimental to its effectiveness as a medium of exchanging and distributing information. Malicious attackers and Internet-fraudsters have found ways of exploiting security holes in systems connected to the Internet to spread viruses and worms, gain access to restricted and private information, gain unauthorized control of systems, and in general disrupt the legitimate use of the Internet. The medium has also been exploited for mass marketing purposes through the transmission of unsolicited bulk e-mails, which is also known as spam. Apart from creating inconvenience for the user on the receiving end of a spam message, spam also consumes network bandwidth at a cost to network infrastructure owners. Furthermore, spam poses a threat to the security of a network because viruses are sometimes attached to the e-mail.

Network security solutions have become an important part of the Internet. Due to the growing amount of Internet traffic and the increasing sophistication of attacks, many network security applications are faced with the need to increase both complexity and processing speed. However, these two factors are inherently conflicting since increased complexity usually involves additional processing.

Pattern matching is an important technique in many information processing systems and has gained wide acceptance in most network security applications, such as anti-virus, anti-spam and intrusion detection systems. Increasing both complexity and processing speed requires improvements to the hardware and algorithms used for efficient pattern matching.

An important component of a pattern matching system is the database of patterns to which an input data stream is matched against. As network security applications evolve to handle more varied attacks, the sizes of pattern databases used increase. Pattern database sizes have increased to such a point that it is significantly taxing system memory resources, and this is especially true for specialized hardware solutions which scan data at high speed.

### BRIEF SUMMARY OF THE INVENTION

In accordance with one embodiment of the present invention, a data compressor performing the compression algorithm compresses an original uncompressed pattern database to form an associated compressed pattern database configured for fast retrieval and verification. In accordance with another embodiment, the data compressor compresses a substring of an input data stream using a hash value generator to generate an associated compressed pattern database also configured for fast retrieval and verification. The compressor which performs the compression algorithm of the present invention maps a sparse, and large universe of hash values into a condensed space. For example, in some embodiments, a 32-bit hash value has a universe of 4,294,967,296 values.

In some embodiments, the compressor is configured to map a plurality of hash values into a single location, thus allowing the hash values to overlap with each other. Accordingly, a substantial number of patterns may be represented in a block of memory to minimize dependence on the memory block size. The present invention thus provides a fast lookup in the compressed space.

Advantageously, a large number of patterns may be represented in a compressed format using a relatively small amount of memory space. This enables large databases to be used with systems having limited memory and further enables memory usage to be tuned for optimum performance. Furthermore, the present invention advantageously enables a very fast lookup of compressed patterns in both hardware-based and software-based systems. Moreover, the present invention enables the user to add or remove patterns efficiently without requiring long compilation times.

### BRIEF DESCRIPTION OF THE DRAWINGS

FIG. 1 is a simplified high-level diagram of a system configured to perform fast pattern using a compressed database, compressed in accordance with one embodiment of the present invention.

FIG. 2 is a diagram of some of the blocks configured to generate a compressed pattern database, in accordance with one embodiment of the present invention.

FIG. 3A shows various fields of an exemplary hash value, in accordance with one embodiment of the present invention.

FIG. 3B shows various fields of an exemplary addressable entry stored in the first memory table, in accordance with one embodiment of the present invention.

FIG. 3C shows various fields of an exemplary addressable entry in the second memory table, in accordance with one embodiment of the present invention.

FIG. 3D shows various fields of an exemplary addressable entry in the second memory table, in accordance with another embodiment of the present invention.

FIG. 3E shows various key-segments of a search pattern, in accordance with one embodiment of the present invention.

FIG. 4 is a flowchart of steps of the compression algorithm, in accordance with one embodiment of the present invention.

FIG. 5 is a flowchart of steps of the compression algorithm in accordance with another embodiment of the present invention.

### DETAILED DESCRIPTION OF THE INVENTION

In accordance with one embodiment of the present invention, a data compressor performing the compression algorithm compresses an original uncompressed pattern database to form an associated compressed pattern database configured for fast retrieval and verification. In accordance with another embodiment, the data compressor compresses a substring of an input data stream using a hash value generator to generate an associated compressed pattern database configured for fast retrieval and verification. The compressor which performs the compression algorithm of the present invention maps a sparse, and large universe of hash values into a condensed space. For example, in some embodiments a 32-bit hash value has a universe of 4,294,967,296 values. As well as storing data in an efficient manner, the compressed database enables the acceleration of content security applications and networked devices such as gateway anti-virus and email filtering appliances.

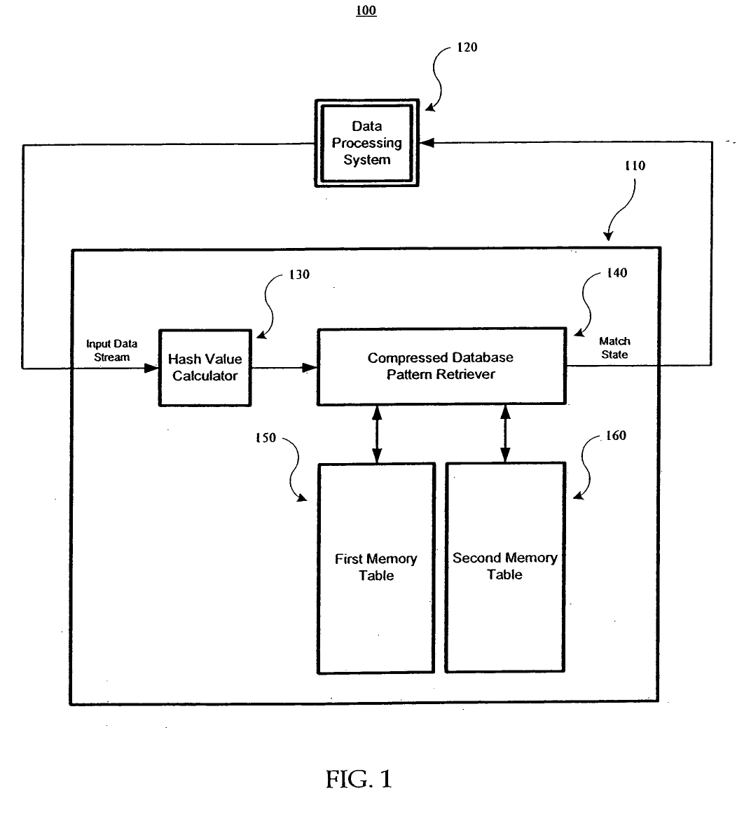

FIG. 1 is a simplified high-level diagram of a system 100 configured to match patterns at high speeds using the compressed database, in accordance with one embodiment of the present invention. System 100 is shown as including a pattern matching system 110 and a data processing system 120. In one embodiment, data processing system 120 is a network security system that implements one or more of anti-virus, anti-spam, intrusion detection algorithms and other network security applications. System 100 is configured so as to support large pattern databases. Pattern matching system 110 is shown as including a hash value calculator 130, a compressed database pattern retriever 140, and first and second memory tables 150, and 160. It is understood that memory tables 150 and 160 may be stored in one, two or more separate banks of physical memory. It is also understood that more than two memory tables can be used to store the compressed database.

Incoming data byte streams are received by the pattern matching system 110 hash value calculator 130. Hash value calculator 130 is configured to compute the hash value for a substring of length N bytes of the input data byte stream (alternatively referred to hereinbelow as data stream). Compressed database pattern retriever 140 compares the computed hash value to the compressed patterns stored in first and second memory tables 150, and 160, as described further below. If the comparison results in a match, a matched state is returned to the data processing system 120. A matched state holds information related to the memory location at which the match occurs as well as other information related to the matched pattern, such as the match location in the input data stream. In one embodiment, if the computed hash value is not matched to the compressed patterns stored in first and second memory tables 150, 160, a no-match state is returned to the data processing system 120. In another embodiment, if the computed hash value is not matched to the compressed patterns stored in first and second memory tables 150, 160, nothing is returned to the data processing system.

A matched state may correspond to multiple uncompressed patterns. If so, data processing system 120 disambiguates the match by identifying a final match from among the many candidate matches found. In such embodiments, data processing system 120 may be configured to maintain an internal database used to map the matched state to a multitude of original uncompressed patterns. These patterns are then compared by data processing system 120 to the pattern in the input data stream at the location specified by the matched state so as to identify the final match.

Since hash value calculator 130 maps many substrings of length N bytes of the input data stream into a fixed-sized pattern search key, there may be instances where a matched state may not correspond to any uncompressed pattern. A “pattern search key” is a fixed-sized pattern that is used for matching against a compressed database created using the present invention. Data processing system 120 is further configured to disambiguate the matched state by verifying whether the detected matched state is a false positive. It is understood that although the data processing system 120 is operative to disambiguate and verify matched state, the present invention achieves a much faster matching than other known systems.

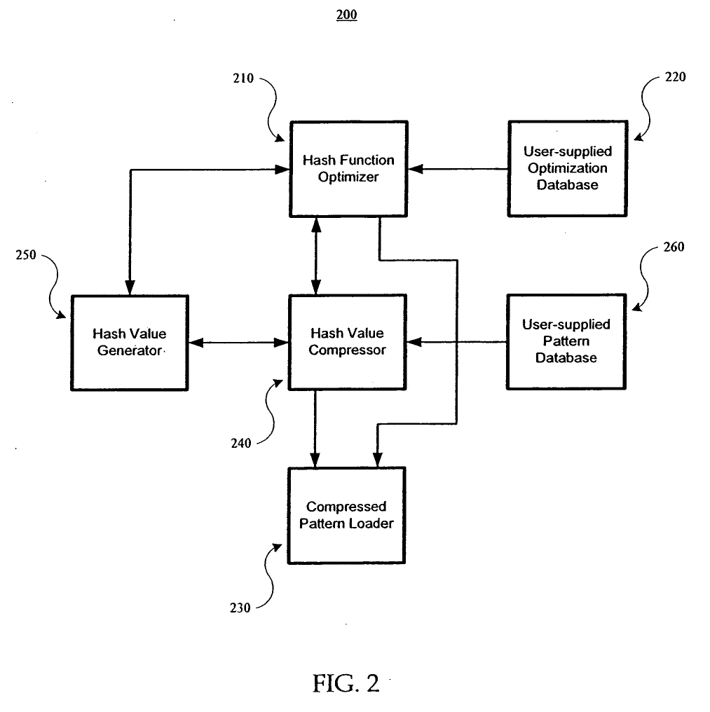

FIG. 2 shows various blocks used to generate a compressed pattern database, in accordance with one embodiment of the present invention. These blocks are shown as hash value generator 250, hash function optimizer 210, hash value compressor 240, compressed pattern loader 230, user-supplied optimization database 220, and user-supplied pattern database 260. Compressed pattern loader 230 performs the function of loading the database of compressed hash values into first memory table 150 and second memory table 160, as well as loading other data associated with the compressed database, such as hash function values, into the hash value calculator 130 and compressed database pattern retriever 140. The compressed pattern loader 230 loads the first memory table 150 and second memory table 160 with values generated by the hash value compressor 240. Hash value compressor 240 reads patterns from a user-supplied pattern database 260, passes them to the hash value generator 250 to generate hash values, and then takes a set of hash values and creates a compressed database that fits into first memory table 150 and second memory table 160. In general, a hash function maps input data to a hash value. The optimal hash function is found by hash function optimizer 210. Various definitions of an optimal hash function can be used. In one embodiment, a hash function is considered optimal if it minimizes the number of ambiguous and false positive matches detected by a pattern matching system that uses the compressed database. Hash function optimizer 210 passes hash functions and input patterns to hash value generator 250 to generate hash values of training data obtained from user-supplied optimization database 220. The generated hash values are read back by hash function optimizer 210 for use in the optimization process. The training data obtained from user-supplied optimization database 220 is used to optimize the hash function in relation to some cost function. Depending on how the cost function is defined, an optimal hash function can be obtained by minimizing, or maximizing, the cost function. The optimal hash function is then used by hash value compressor 240 for compressing a set of hash values using the two memory tables. The optimal hash function is then loaded into hash value calculator 130 by compressed pattern loader 230.

In one embodiment, hash value generator 250 generates hash values using the recursive cyclic polynomial algorithm. The code that implements this algorithm is shown below and which is configured to generate a stream of hash values for a stream of input data, e.g., symbols.

// Calculate hash values using “m_originalMem” as the input data stream, and
// “m_hashedValueMem” is the output data stream.
// Note that the first (m_nGramLength − 1)*m_numAddressBytes bytes are invalid
// at the output.
unsigned int CPRecursiveHash::CalcHash (unsigned int inputLen)
{

int i;
unsigned int k;
int hashIndex = −1;
unsigned int tempHashWord;
for ( i = 0; i < (int) inputLen; ++i )
{

// perform hashing
m_hashWord = SlowBarrelShiftLeft (m_hashWord, m_delta);
m_hashWord \hat{ }= m_transformationT[m_originalMem[i]];
if ( i >= m_nGramLength )
{

m_hashWord \hat{ }= m_transformationTPrime[m_nGramBuffer[0]];

}
// update ngram fifo buffer
memmove((void *)&m_nGramBuffer[0],(void *)&m_nGramBuffer[1], m_nGramLength − 1);
m_nGramBuffer[m_nGramLength − 1] = m_originalMem[i];
// use the hash value (stored in m_hashWord), and/or send it to output
// note that this hash value can be used directly (or an offset added to it)
// to address a pattern memory.
// the code below is just an example of a possible use of the hash value
tempHashWord = m_hashWord;
for ( k = 0; k < m_numAddressBytes; ++k )
{

m_hashedValueMem[++hashIndex] = tempHashWord & 0xFF;
tempHashWord >>= 8;

}

}
return hashIndex + 1;

}
inline unsigned int CPRecursiveHash::SlowBarrelShiftLeft(unsigned int input,

unsigned int numToShift)

{

return (input << numToShift) | ((input >> (m_numWordBits − numToShift)));

}

The above code does not show the initializations routine. Initialization parameters include the size of the N-gram, the amount of shift and the number of bits used for the hash values. Variable initializations include the creation of internal buffers, and the setting of default values. An important step in the initialization process is the creation of the transformation tables, as described in copending application ______, entitled “Fast Pattern Matching Using Large Compressed Databases” which is incorporated herein by reference in its entirety. The values in the two transformation tables determine the characteristics of the hash value function.

The hash function optimizer 210 finds the optimum hash function for the particular application domain. For 8-bit symbols, there are 256 entries in each table, and each entry is 32 bits for a 32-bit hash value. The present state of knowledge on recursive hash functions supports the position that currently there are no known optimal and efficient ways of selecting the best values for the tables such that hash values are well separated. Instead, brute-force approaches, or approximate methods based on non-linear optimization techniques and/or heuristics can be used. In all cases, the general guideline is to have the contribution of a symbol to a hash value word scattered across the word while changing about half of the total number of bits. Hash function optimizer 210 is further adapted to use standard non-linear function optimization methods, as known, to optimize the hash function for the application domain.

In one embodiment, the recursive hash function is used for pattern matching, and this involves the use of a user-supplied reference pattern database to which input patterns are compared for a positive match. A pattern is classified as a positive pattern if it exists in the reference database, otherwise it is classified as a negative pattern. Hash values are computed for each pattern in a pattern database and loaded into the recursive hash pattern matching system. An input stream is then hashed for each input symbol and the hash values compared to the database of hash values for a positive match. For efficient hash value pattern matching, the number of false positive matches arising from negative input patterns is minimized by using an optimum hash function generated by the hash function optimizer 210.

The values in the transformation tables may further be used to reduce the number of hash value collisions between a negative input pattern and a positive input pattern from the training database. This is a non-linear optimization problem where the function to be optimized encompasses the calculation and matching of the hash values and the tabulation of the total number of negative and positive matches. The function is highly non-linear, thus the gradient of this function is difficult and may be impossible, to determine. Therefore, optimizing it requires an optimization algorithm that does not rely on gradient information.

In one embodiment, hash function optimizer 210 is based on the genetic algorithm, see for example, “Genetic Algorithms in Search, Optimization and Machine Learning”, David E. Goldberg, Kluwer Academic Publishers, Boston, Mass., 1989. Thus, a chromosome represents an individual, and each chromosome is represented by the values of the transformation table T. Running the optimizer requires the fitness of chromosomes to be evaluated. To do this, a negative database, i.e., a database where negative patterns can be extracted, is required. Such a database is generated randomly with different probabilities given to different symbols. In one embodiment, the ASCII character set is assumed and larger probabilities are given to the alphanumeric characters and the space character. Other probabilities are given to special characters. Adjusting the probabilities allow a realistic-looking negative database to be generated. This database is re-generated every m iterations of the chromosome evaluation function to maintain randomness and prevent over specialization to a specific negative database. An example of the probabilities assigned to the various characters in the ASCII character set is shown below:

| | |
|---|---|
| Lower Case Alphabet (‘a’ to ‘z’): | 45% |
| Upper Case Alphabet (‘A’ to ‘Z’): | 20% |
| Numerical Characters (‘0’ to ‘9’): | 20% |
| Others: | 10% |
| Space Character (‘ ’): | 5% |

Other optimization methods can also be used in place of the genetic algorithm. One example of an alternative method is optimization by simulated annealing. The hash value compressor 240 compresses the universe of possible hash values into one that is in the order of the number of unique patterns. This algorithm assumes that hash values are pre-computed and available.

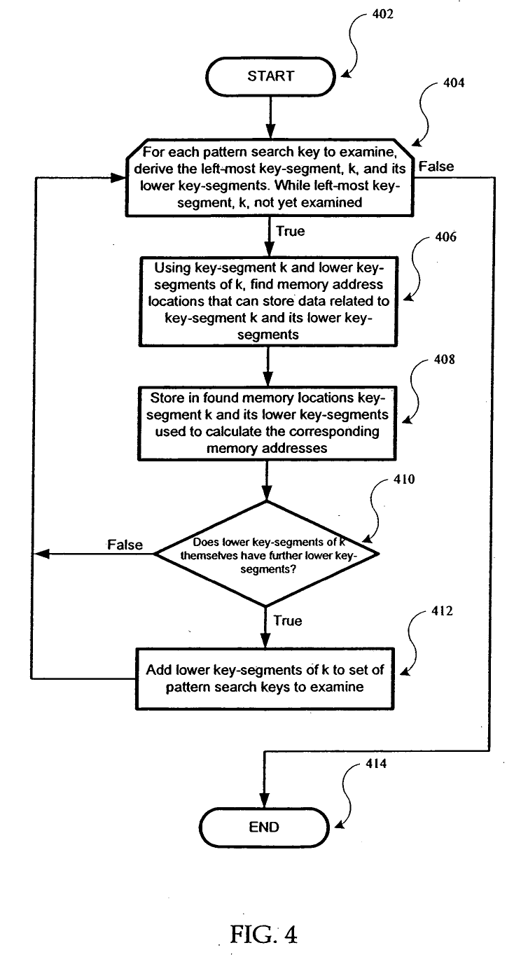

FIG. 4 is a flowchart illustrating the compression algorithm operating with a plurality of memory tables, in accordance with one embodiment of the present invention. The flowcharts show the basic concepts behind the hash value compression algorithm. Without loss of generality, the concepts are illustrated with an embodiment that uses only two memory tables, although those skilled in the art understand that other embodiments of the invention may use more than two memory tables. The following is a pseudo-code configured to compress data in accordance with the flowchart of FIG. 4:

| | |
|---|---|
| 1. | While there are more patterns |

| | |
|---|---|
| 2. | Calculate the hash value for an N-gram of the current pattern |
| 3. | Extract the first-key-segment and second-key-segment from the hash value, and the number of patterns that overlap onto this hash value |
| 4. | Store the second-key-segment and overlap amount in a structure indexed by the first-key-segment, and call this structure CIHashKey |

| | |
|---|---|
| 5. | End While |
| 6. | Create structure hashMemNumOverlapMap that stores the number of overlaps per entry in the Second Memory Table. |
| 7. | For each first-key-segment in CIHashKey |

| | |
|---|---|
| 8. | Set variable offset to zero, and set memExhausted to false |
| 9. | While boolean variables fit and memExhausted are both false |

| | |
|---|---|
| 10. | Set fit and allEntriesSame to true, and set numOverlaps to zero |
| 11. | For each second-key-segment corresponding to the current first-key-segment |

| | |
|---|---|
| 12. | Retrieve the corresponding second-key-segment |
| 13. | Calculate Second Memory Table offset as memAddr = RoundDown((offset + second-key-segment)/2) |
| 14. | Readjust total memory usage based on variable memAddr and return error if maximum allowable size reached |
| 15. | If !IsOdd(offset + second-key-segment) then |

| | |
|---|---|
| 16. | /* Using first-sub-entry */ |
| 17. | If the ‘use bit’ in the first-sub-entry at memory location memAddr is not set then |

| | |
|---|---|
| 18. | Remember the current value of the first-sub-entry of memAddr |
| 19. | Set the first-sub-entry of memAddr to current first-key-segment and set the corresponding ‘use bit’ |
| 20. | Set hashMemNumOverlapMap indexed by (offset + second-key-segment) to equal current overlap amount |

| | |
|---|---|
| 21. | Else |

| | |
|---|---|
| 22. | /* this sub-entry is already used, so check to see if first-key-segment is the same and record the overlap amount */ |
| 23. | Set fit to false |
| 24. | If current second-key-segment is the first one examined then |

| | |
|---|---|
| 25. | Set variable fVal to equal the first-sub-entry at memAddr without the ‘use bit’ |
| 26. | Set variable numOverlaps to equal hashMemNumOverlapMap [offset + second-key-segment] |

| | |
|---|---|
| 27. | Else |

| | |
|---|---|
| 28. | If fVal is not equal to the first-sub-entry at memAddr without the ‘use bit’ then |

| | |
|---|---|
| 29. | Set variable allEntriesSame to false and break out of closest enclosing loop |

| | |
|---|---|
| 30. | End If |
| 31. | Increment numOverlaps by hashMemNumOverlapMap[offset + second-key-segment] |

| | |
|---|---|
| 32. | End If |

| | |
|---|---|
| 33. | End If |

| | |
|---|---|
| 34. | Else |

| | |
|---|---|
| 35. | /* Using second-sub-entry */ |
| 36. | If the ‘use bit’ in the second-sub-entry at memory location memAddr is not set then |

| | |
|---|---|
| 37. | Remember the current value of the second-sub-entry of memAddr |
| 38. | Set the second-sub-entry of memAddr to current first-key-segment and set the corresponding ‘use bit’ |
| 39. | Set hashMemNumOverlapMap indexed by (offset + second-key-segment) to equal current overlap amount |

| | |
|---|---|
| 40. | Else |

| | |
|---|---|
| 41. | /* this entry is already used, so check to see if first-key-segment is the same and record the overlap amount */ |
| 42. | Set fit to false |
| 43. | If current second-key-segment is the first one examined then |

| | |
|---|---|
| 44. | Set variable fVal to equal the second-sub-entry at memAddr without the ‘use bit’ |
| 45. | Set variable numOverlaps to equal hashMemNumOverlapMap [offset + second-key-segment] |

| | |
|---|---|
| 46. | Else |

| | |
|---|---|
| 47. | If fVal is not equal to the second-sub-entry at memAddr without the ‘use bit’ then |

| | |
|---|---|
| 48. | Set variable allEntriesSame to false and break out of closest enclosing loop |

| | |
|---|---|
| 49. | End If |
| 50. | Increment numOverlaps by hashMemNumOverlapMap [offset + second-key-segment] |

| | |
|---|---|
| 51. | End If |

| | |
|---|---|
| 52. | End If |

| | |
|---|---|
| 53. | End If |

| | |
|---|---|
| 54. | End For |
| 55. | If fit is false then |

| | |
|---|---|
| 56. | Restore the memAddr locations that were set within this ‘While’ loop that had values of zero previously |
| 57. | If allEntriesSame is true then |

| | |
|---|---|
| 58. | Compare value of numOverlaps with current minimum value and record ‘best’ entry details if it is smaller |
| 59. | If an entry was recorded then set variable foundOverlap to true |

| | |
|---|---|
| 60. | End If |
| 61. | Increment offset by one |

| | |
|---|---|
| 62. | End If |

| | |
|---|---|
| 63. | End While |
| 64. | If fit is false then |

| | |
|---|---|
| 65. | If foundOverlap is true then |

| | |
|---|---|
| 66. | Iterate through Second Memory Table and set unused entries to ‘best’ entry values found previously |
| 67. | Set First Memory Table at location indexed by current first-key-segment to the ‘best’ entry values found previously |
| 68. | For each second-key-segment corresponding to the current first-key-segment |

| | |
|---|---|
| 69. | If hashMemNumOverlapMap with index given by the ‘best’ offset found previously plus second-key-segment exists then |

| | |
|---|---|
| 70. | Set hashMemNumOverlapMap indexed by (‘best’ offset + second-key-segment) to equal current overlap amount |

| | |
|---|---|
| 71. | Else |

| | |
|---|---|
| 72. | Increment hashMemNumOverlapMap indexed by (‘best’ offset + second-key-segment) by current overlap amount |

| | |
|---|---|
| 73. | End If |

| | |
|---|---|
| 74. | End For |

| | |
|---|---|
| 75. | Else |

| | |
|---|---|
| 76. | Print error message: “memory exhausted” |

| | |
|---|---|
| 77. | End If |

| | |
|---|---|
| 78. | Else |

| | |
|---|---|
| 79. | Set First Memory Table at location indexed by current first-key-segment with current first-key-segment and offset values |

| | |
|---|---|
| 80. | End If |

| | |
|---|---|
| 81. | End For |

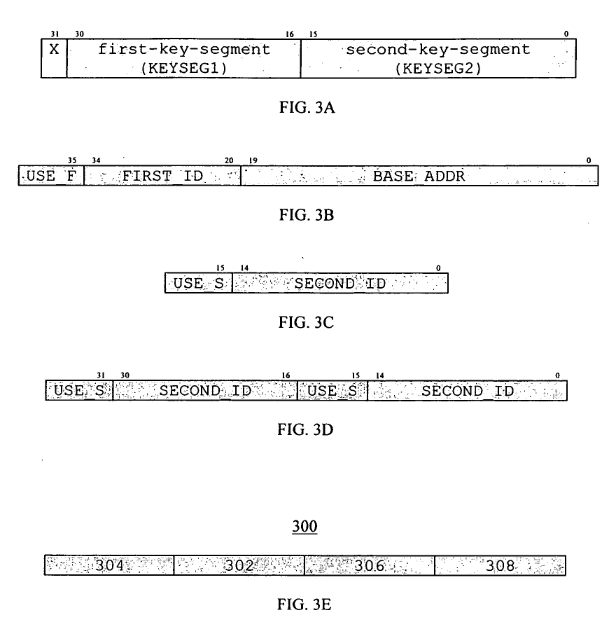

In one embodiment, a pattern search key is decomposed into a first-key-segment and a second-key-segment (see FIG. 3A). In one embodiment, a pattern search key is a hash value. Lines 1 to 5 of the pseudo-code set up the data structures necessary for the compression algorithm. This structure is referred to herein as CIHashKey, and is indexed by the first-key-segment. Each entry stores a list of second-key-segments, and for each second-key-segment a count of the number of patterns that overlap onto the combined hash value is maintained. The outer loop, starting on line 7, iterates through each element of CIHashKey indexed by the first-key-segment. The next inner ‘while loop’ attempts to fit all the hash values indexed by the current first-key-segment into the second memory table 160. It does this by trying out all possible memory locations, and in the process determines the best location where valid hash values overlaps may occur with the minimum number of collisions. At the end of the while loop, if the hash values with the current first-key-segment cannot fit into the second memory table 160 without collision, then another overlap location is used. In one embodiment, if no overlap location is found, then the memory is exhausted and compression fails. In another embodiment, if no overlap location is found, then the contents of the memory are re-adjusted until a non-overlap or overlap location is found. Provided that the second memory table satisfies a minimum size requirement, it is always possible to re-adjust the memory by changing BASE_ADDR in the relevant first memory table entries such that the hash values to be added to the database fits in the second memory table. In this embodiment, the most extreme case of overlapping causes every hash value added to be ambiguous in the sense that each hash value corresponds to multiple uncompressed patterns. Therefore, further match disambiguation will need to be carried out by the pattern matching application that uses this architecture.

The inner for loop encompassing lines 11 through 54 iterates over all the second-key-segments for the current first-key-segment. On line 13, the second memory table 160 address is calculated using the current second-key-segment, and this address must reside within a valid range, otherwise an error is raised on line 14. The calculated second memory table 160 address is divided by two, because each second memory table 160 entry stores two first-key-segment entries. The remainder from the division is used to select the sub-entry for that address. Lines 16 to 33 are associated with the first-sub-entry, and lines 35 to 52 are associated with the second-sub-entry. In both cases, a test is made to see if that particular entry is used. If not, then the use bit is set and the rest of the entry is set to the current first-key-segment. A record is made that indicates whether this entry is previously unused as this entry will be reset if a later second-key-segment is encountered that collides with an existing entry. Line 56 illustrates the use of this record to reset previously unused entries. In contrast, if that particular entry is already used, then an attempt is made to see if overlapping the current hash value into the existing value is possible. If it is, then this entry is marked and the current number of overlapping values mapped to this entry is recorded. At the end of the “While” loop, if an unsuccessful attempt has been made at placing the hash keys into the second memory table 160 without overlapping, then the entries that are recently added into the second memory table 160 and previously unused are now reset back to the unused state. At the same time, previously recorded overlapping information is used to map the current first-key-segment to another first-key-segment, thus overlapping the corresponding hash values into existing hash values. In all cases, the first-key-segment in the first memory table 150 is set to the current first-key-segment if overlapping is not required; otherwise it is set to the first-key-segment of the set of hash values that it overlaps on.

FIG. 3A shows various fields of an exemplary 32-bit hash value, in accordance with one embodiment of the present invention. Bits 0-30 are divided into two sub-keys. The first sub-key denoted as KEYSEG1 includes bits 30-16 of the hash value. The second sub-key denoted as KEYSEG2 includes bits 15-0 of the hash value. The first-key-segment, KEYSEG1, is used to generate an address in the first memory table 150. The second-key-segment, KEYSEG2, is used as an offset to generate an address in the second memory table 160.

FIG. 3B shows various segments of each exemplary 36-bit entry in first memory table 150. Bit USE_F indicates whether the entry is valid. A bit USE_F of 0 indicates that the value being looked up does not exist in the database, thus obviating the need to access the second memory table 160. Bits 19-0 of an entry in the first memory table 150, forming field BASE_ADDR, point to an address in the second memory table 160. Bits 34-20 of an entry in the first memory table 150, form field FIRST_ID. In one embodiment, the value of FIRST_ID is set to be equal to KEYSEG1. Using a different value of FIRST_ID in first memory table 150 for a given KEYSEG1 parameter allows first-key-segments of the hash value to map to a different first-key-segment in the first memory table. This enables different hash values to logically, and not necessarily physically, to overlap each other in the first-key-segment in the second memory table 160. Logical overlapping may be required when memory has been exhausted and the addition of another hash value may result in at least one match with an existing entry. Overlapping patterns create ambiguous matches, but allows more patterns to be stored in the database.

FIG. 3C shows various fields of an exemplary addressable entry in the second memory table, in accordance with one embodiment of the present invention. Each entry includes a use bit USE_S, and a data field SECOND_ID for storing a first-key-segment. During the compression process, the SECOND_ID field is set to the corresponding value of KEYSEG1 field that generated that entry's address. In this embodiment, the value of SECOND_ID field must match the value of FIRST_ID for a positive match to occur. It is understood that more entries may be stored into wider memories. For example, if 32 bit-wide memories are used for the second memory table 160, then two USE_S and two SECOND_ID values may be stored in each entry of the second memory table, as shown in FIG. 3D described below. In such a case, bits 31-16 may store the first sub-entry, collectively referred to as the first-sub-entry. Similarly, bits 15-0 may store the second sub-entry, collectively referred to as the second-sub-entry. The logical meaning of each sub-entry is identical. Using two sub-entries for each entry in second memory table 160 reduces the memory usage in the table by half. Using wider memories enables a plurality of sub-entries to be stored in each memory location.

In the above exemplary embodiment, each hash value is shown as including 32 bits. Allocating one extra bit to each hash value doubles the amount of overall space addressable by the hash value, thus reducing the probability of unwanted collisions in the compressed memory tables. However, it also increases the number of bits required for the FIRST_ID and/or SECOND_ID fields as more hash value bits would require validation. The sizes of FIRST_ID and SECOND_ID are limited by the width of the memories. Therefore, using 32 bit hash values require an extra bit for the FIRST_ID field and this can be accomplished by a corresponding reduction in the number of bits used to represent BASE_ADDR in the second memory table, because the full width of the memories are already utilized.

In the above example, BASE_ADDR is represented by 20 bits, thus permitting the use of an offset into the second memory table 160 that can address up to 2²⁰=1,048,576 different locations. A reduction in the space addressable by BASE_ADDR reduces the total amount of usable space in the second memory table 160, which increases the number of undesirable of pattern search key collisions. It is understood that more or fewer hash value bits may be used in order to increase or reduce the number of unwanted pattern search key collisions. The number of bits available to BASE_ADDR may decrease to the point where the actual number of unwanted pattern search key collisions may actually increase due to the reduction in the amount of addressable space in the second memory table 160.

In one embodiment, the value of KEYSEG1 is added to a first offset value to compute an address for the first memory table 160. In the above example, KEYSEG1 includes 15 bits, thus requiring a first memory block that includes 2¹⁵=32,768 entries. The use of the offset, facilitates the use of multiple blocks of first-key-segments in the first memory table 150. This enables multiple independent pattern databases to be stored within the same memory tables. The values are chosen in a manner that allows the compressed pattern databases to remain independent of each other.

The base address, BASE_ADDR, retrieved from the first memory table 150 at the location defined by the parameters KEYSEG1 and the first offset, is subsequently added to a second offset value and further added to parameter value KEYSEG2 to determine an address in the second memory table 160. The second offset facilitates the use of multiple second-key-segment blocks that correspond to different hash functions. Therefore, multiple and independent pattern databases can be stored in the same memory tables by using appropriate values for the second offset value.

FIG. 3D shows various fields of an exemplary addressable entry in the second memory table, in accordance with another embodiment of the present invention. In order for a positive match to occur the use-bits, USE_F and USE_S, have to be set. During the pattern compression process, a use bit is set if the entry stores a corresponding training pattern, otherwise it is cleared. The use bits are set or cleared when the training patterns are compiled, compressed and loaded into the tables. Therefore, a cleared use bit indicates a no-match condition. In some embodiments, if the use-bit in the first memory table is cleared then the lookup of the second memory table 160 may be bypassed so that the next processing cycle can be allocated to the lookup of the first memory table 150 instead of the second memory table 160, therefore, the next match cycle begins in the first memory table 150 and the second memory table 160 is not accessed. Consequently, the overall system operates faster because extra memory lookups are not required.

Referring to FIG. 2, hash value compressor 240 loads the first memory table 150 and second memory table 160 with the appropriate values. Furthermore, patterns that hash to the same hash value, whether as a result of the characteristics of the hash function or the overlapping performed by the compression algorithm, are assigned the same identifier at the application level, that is, the application that uses this architecture. At the compressed database level, the same identifier is already implicitly enforced by having patterns that map to the same address.

Once the optimal hash function is determined, the corresponding transformation tables can be used by the hash value compressor 240 to determine the contents of the first memory table 150 and second memory table 160. The contents of these memories are loaded into the compressed database pattern retriever 140 by compressed pattern loader 230. The application calling compressed pattern loader 230 provides the appropriate offsets into the two memory tables where the pattern data is to be loaded. The contents of the transformation tables are also loaded by compressed pattern loader 230.

The compressed database architecture of the present invention also supports efficient incremental insertion and removal of patterns. For example, in one embodiment, a single pattern can be added to the compressed database by calculating the hash value, extracting the hash value segments, and adding the new hash value to the compressed database if an empty entry exists in the second memory table 160 or if the overlapping of hash values is performed. If the new hash value cannot be added using this method, then the relevant groups of hash values can be moved to a different memory location to enable the successful insertion of the new hash value. Similarly, a single pattern may be removed from the compressed database by clearing the relevant entries in the second memory table 160, and, if necessary, the relevant entry in the first memory table 150. The latter operation is possible if no other patterns have the same first-key-segrnent. The removal of entries is performed only if the entries being cleared are non-overlapping; otherwise a count of the number of overlapping patterns is decreased by one. A non-overlapping entry is one where the count value is one. Such a count can be stored in the extra bits that may be available in each entry of the second memory table 160, or it can be stored at the application level, that is, the external application using this architecture.

The compression algorithm described above, may be applied to the compression of data other than hash values. The compression algorithm is also applicable to the compression of any database of patterns of constant length. For example, data processing system 120 containing patterns of constant length can feed data directly to the compressed database pattern retriever 140, thus bypassing the hash value calculator 130.

If a database contains patterns that are not of constant length, then one of many available techniques may be used to provide a constant length. For example, the database may contain patterns that have lengths ranging from 16 bits to 180 bits long. In another embodiment, the padded patterns are mapped using a hash function to obtain a value that is shorter in length. For example, patterns that are less than 32 bits in length can be padded with zero-value bits to have constant lengths of 32 bits. Furthermore, patterns that are more than 32 bits in length can be truncated to 32 bits. Once the compressed database structure is established, the validity of a hash value may be verified. In one embodiment, shorter patterns are padded with zeros to force them to have constant length. In another embodiment, the padded patterns are mapped using a hash function to obtain a value that is shorter in length. In yet another embodiment, a new set of proper-length patterns is created from each shorter length pattern, where each new proper-length pattern is created from the shorter length pattern by appending it with one set of possible symbols. All sets of possible symbols are used to create the new set of proper-length patterns.

The algorithm that compresses data in accordance with the present invention examines each key-segment of each pattern search key. In one embodiment, a pattern search key is a hash value. In one embodiment, the pattern search key is decomposed into more than two key-segments. Merely as an example, a pattern search key is decomposed into N key-segments, where N is greater than one and the decomposed key-segments are referred to as first, second, third, etc. from left to right in the decomposed pattern search key. For a given key-segment, a memory address is derived for the group of at least one or more key-segments to the right of that given key-segment. A group of at least one or more key-segments occurring to the right of a key-segment is also referred to as lower key-segments. Merely as an example, FIG. 3E shows various segments of each pattern search key (i.e., hash value) 300. Each pattern search key 300 includes a current key-segment 302 undergoing compression, as described below, lower key-segments comprising 306 and 308, and a previously examined key-segment 304. In one embodiment, the pattern search key 300 is 32 bits in length.

Each memory address derived for the group of at least one or more key-segments to the right of a current key-segment is examined to see if information on the current key-segment and lower key-segments that generated that address can be stored in that memory location. If it is not possible to store information in that memory location due to collision with an existing entry, then further memory locations are derived from the corresponding key-segment and lower key-segments until an appropriate memory location is determined. Next, the lower key-segments are examined to determine if they contain more than one key-segment. If so, the left-most key-segment in the lower key-segments is added to the list of key-segments to examine and new lower key-segments derived, and the loop is repeated, as described further below.

FIG. 4 is a flowchart 400 of steps carried out to compress data in accordance with one exemplary algorithm of the present invention. Data compression of a set of pattern search keys start at step 402. At step 404, the left-most key-segment and the corresponding lower key-segments are derived from each pattern search key. A determination is then made as to whether the left-most key-segment of each pattern search key has been examined. If so, transition is made to step 414 to terminate the process. If not, at step 406, using key-segment k and lower key-segments corresponding to key-segment k, a memory address location that can store data related to these key-segments is computed. At step 408, the key-segment used in computing the addresses are stored in these addresses. At step 410, a determination is made as to whether the lower key-segments of key-segment k themselves have further lower key-segments. If so, the process moves to step 412 and the lower key-segments of key-segment k is added to the set of pattern search keys to be examined, after which the process moves to step 404. If it is determined that the lower segments of key-segment k do not themselves have further lower key-segments, the process moves to step 404 and step 412 is bypassed.

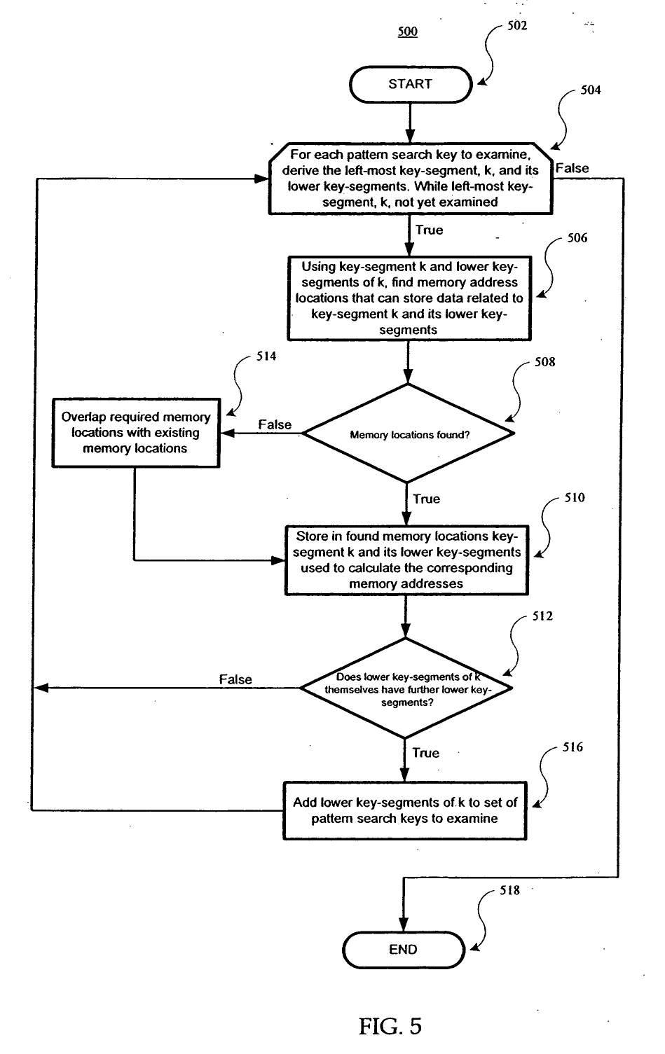

In accordance with another compression algorithm of the present invention, overlapping of pattern search keys is taken into account. Overlapping of pattern search keys is used to increase the compression ratio at the expense of an increase in false positives during pattern search key lookups. Overlapping can be carried out in a logical manner where actual overlapping is not carried out, but instead noted by the use of a flag, or it can be carried out in a physical manner where actual overlapping of patterns is implemented by, for example, storing a multitude of pattern search key information in a memory location. FIG. 5 is a flowchart 500 of steps carried out to compress data in accordance with such an algorithm. Data compression of a set of pattern search keys start at step 502. At step 504, the left-most key-segment and the corresponding lower key-segments are derived from each pattern search key. A determination is then made as to whether the left-most key-segment of each pattern search key has been examined. If so, the process moves to step 518 to terminate the process. If not, at step 506, using key-segment k and lower key-segments corresponding to key-segment k, a memory address location that can store data related to these key-segments is computed. If appropriate memory locations are found at step 508, the key-segments used in computing the memory locations are stored in such locations at step 510 and transition is made to step 512. If appropriate memory locations are not found at step 508, the contents to be stored in the required memory locations are overlapped or combined with the contents in the existing memory locations at step 514, after which a transition is made to step 510 where memory locations are updated, and then a transition is made to step 512. At step 512, a determination is made as to whether the lower segments of key-segment k themselves have further lower key-segments. If so, the process moves to step 516 and the lower key-segments of key-segment k is added to the set of pattern search keys to be examined, after which the process moves to step 504. If it is determined that the lower segments of key-segment k do not themselves have further lower key-segments, transition is made to step 504 and step 516 is bypassed.

Although the foregoing invention has been described in some detail for purposes of clarity and understanding, those skilled in the art will appreciate that various adaptations and modifications of the just-described preferred embodiments can be configured without departing from the scope and spirit of the invention. For example, other pattern matching technologies may be used, or different network topologies may be present. Moreover, the described data flow of this invention may be implemented within separate network systems, or in a single network system, and running either as separate applications or as a single application. Therefore, the described embodiments should not be limited to the details given herein, but should be defined by the following claims and their full scope of equivalents.

What is claimed is:

1. A method comprising:
storing a first data in a first address of a first memory table, wherein said first address is defined by a first segment of a group of bits associated with a data pattern; and
storing a second data in a first address of a second memory table, wherein said first address of the second memory is defined by a second segment of the group of bits associated with the data pattern and further defined by the first data stored in the first memory.

2. The method of claim 1 further comprising:
storing a third data in the first address of the first memory; and
storing a fourth data in the first address of the second memory.

3. The method of claim 1 further comprising:
declaring a match if a data stored in a second address of the second memory table includes a second address of the first memory table and whose content is used to define the second address in the second memory table.

4. The method of claim 2 further comprising:
declaring a match if the third data matches the fourth data.

5. The method of claim 1 wherein the group of bits is hash value computed from the data pattern.

6. The method of claim 1 wherein the first and second memory tables reside in the same memory device.

7. The method of claim 3 further comprising:
storing a third data in the first memory table and configured to indicate whether to read the second memory table after reading the first memory table.

8. The method of claim 2 further comprising:
storing a fifth data in the first memory table and configured to indicate whether to read the second memory table after reading the first memory table.

9. An apparatus comprising:
a first module adapted to store a first data in a first address of a first memory table, wherein said first address is defined by a first segment of a group of bits associated with a data pattern; and
a second module adapted to store a second data in a first address of a second memory table, wherein said first address of the second memory is defined by a second segment of the group of bits associated with the data pattern and further defined by the first data stored in the first memory.

10. The apparatus of claim 9 further comprising:
a third module adapted to store a third data in the first address of the first memory; and
a fourth module adapted to store a fourth data in the first address of the second memory.

11. The apparatus of claim 9 further comprising:
a module adapted to declare a match if a data stored in a second address of the second memory table includes a second address of the first memory table and whose content is used to define the second address in the second memory table.

12. The apparatus of claim 10 further comprising:
a module adapted to declare a match if the third data matches the fourth data.

13. The apparatus of claim 9 wherein the group of bits is hash value computed from the data pattern.

14. The apparatus of claim 9 wherein the first and second memory tables reside in a same memory device.

15. The apparatus of claim 11 further comprising:
a module adapted to store a third data in the first memory table and configured to indicate whether to read the second memory table after reading the first memory table.

16. The apparatus of claim 10 further comprising:
a module adapted to store a fifth data in the first memory table and configured to indicate whether to read the second memory table after reading the first memory table.
